(19) United States
(12) Patent Application Publication
(10) Pub. No.: US 2005/0164760 A1
(43) Pub. Date: Jul. 28, 2005

(54) Combination live table and video screen display games

(76) Inventor: Ernest W. Moody, Las Vegas, NV (US)

Correspondence Address: JOHN EDWARD ROETHEL, 2290 S. JONES BLVD. #100, LAS VEGAS, NV, 89146, US

(21) Appl. No.: 11/039,467

(22) Filed: Jan. 19, 2005

Related U.S. Application Data
(60) Provisional application No. 60/538,078, filed on Jan. 20, 2004.

(51) Int. Cl. G06F 17/00

(52) U.S. Cl. 463/12

(57) ABSTRACT

The method and apparatus allows the players to play a live casino game such as poker or Twenty-One at a standard gaming table and also allows the players to make one or more wagers on a different game or an extension of the live table game. This different game or extension game takes place on a video screen display that allows the players to make one or more additional bets and play a different game or an extension game on the screen video display. Additional bets may be made by the player using casino chips or player credits on the video display using a button panel by either the player or the dealer. The button panel could also be used by the player or the dealer to input any decisions made by the player regarding the video aspect of the game.

### CROSS-REFERENCE TO RELATED APPLICATION

This application claims the benefit of provisional application Ser. No. 60/538,078, filed Jan. 20, 2004, entitled “Combination Live Table and Video Screen Display Games.”

This invention relates to casino games, and more particularly to live casino games combined with a video screen display.

### BACKGROUND OF THE INVENTION

Traditional live table casino games such as Poker, Twenty-One and Craps have remained essentially unchanged for many years. Players like live table games because of the social aspects of playing a game with multiple people at the same table and the ability to have verbal interaction with the dealer and the other players. Players also like the physical aspects of table games such as the ability to touch and feel the cards and see the deck being shuffled and dealt. Table games in the past have been limited in their design and complexity because of the physical limitations of space on the gaming table and the need for the game to play quickly and easily.

On the other hand, mechanical and electronic slot machines and video poker machines have evolved at a much faster rate due to the increasing pace of technological development. While these games do not offer the same degree of social and physical interaction between the player and others playing similar games, these games do offer the latest in computer technology including high resolution graphics and sound. The advances in computer technology allow the gaming machine manufacturers to offer very sophisticated games with an ever increasing amount of player interaction with the gaming machine during the course of play of a game of chance.

It is also known to play traditional live table games such as poker and Twenty-One using a full video representation of the gaming table. The players sit around a gaming table which is equipped with a video monitor at each player location and a larger video monitor located at the dealer location. Instead of using a live dealer, this apparatus uses a video representation of the dealer. Instead of using live playing cards, video representations of the playing cards are displayed to each player on his video monitor at the player's location. Each player makes his wagers and plays his hand of cards by interacting with the video monitor by pressing buttons or touch screen locations. The computer controls and game electronics handle the game operation including the dealing of the cards, the play of the dealer's hand, the determination of winning and losing outcomes and the payment of winning wagers and the collection of losing wagers.

It is also known to provide a hybrid of the above-described full video representation of poker and Twenty-One in which a real, live dealer is used in place of the video representation of the dealer. This hybrid uses computer controls and game electronics to handle a portion of the game operation including the dealing of the cards, the play of the dealer's hand and the determination of winning and losing outcomes. However, because a live dealer is used, the players can make their wagers using conventional casino gaming chips. Also, the payment of winning wagers and the collection of losing wagers is performed by the live dealer using a chip rack and gaming chips as is traditional at a live casino gaming table.

However, neither of these known apparatuses or methods of play allow a player to participate in a second game of chance while playing the live table game.

The present invention retains much of what the player enjoys about live table games while at the same time allowing the players the option of playing a part of the game or an entirely different game on a video display screen. This allows a traditional type of live table game to offer new features and a new degree of complexity while at the same time preserving the social aspects and ease of play of the live table game.

### SUMMARY OF THE INVENTION

The method and apparatus of the present invention allows the players to play a live casino game such as poker or Twenty-One at a standard gaming table and also allows the players to make one or more wagers on a different game or an extension of the live table game. This different game or extension game takes place on a video screen display that is provided to the player as part of the gaming experience at the standard gaming table.

The main feature of the present invention is that a table game is provided with one or more video screen displays that are visible to the players. The layout of the screen displays allows the players to make one or more additional bets and play a different game or an extension game on the screen video displays. This is accomplished by having the screen displays show information, buttons and other indicia or data to the player. The information, buttons and other indicia displayed to the player are part of a different game altogether or an extension of the live game being played on the gaming table.

Additional bets may be made by the player using casino chips or player credits on the video display. These additional bets may be input into the video game using a button panel by either the player or the dealer. The button panel could also be used by the player or the dealer to input any decisions made by the player regarding the video aspect of the game.

### DETAILED DESCRIPTION OF THE PREFERRED EMBODIMENTS

The present invention combines a live table game with video displays so that the players can play a live card game such as poker or Twenty-One at a standard gaming table and also make wagers to play a different game or an extension game of the live table game on the screen video display.

In a preferred embodiment of the present invention, the gaming table used in the live table game is provided with one or more video screens that are visible to the players. For example, each player location around the gaming table used in the live table game has a video screen display associated therewith. The video screen can be positioned immediately in front of each player. Other electronic devices such as a button panel may be provided in association with the video screen display.

Using touch screen technology, each video screen display can have a layout that allows the player to make additional bets and play an extension of the live table game on the video screen display. This can be accomplished by having the video screen display show to the player the indicia related to the live table game. The indicia displayed to the player may be a part of the game that the player is playing in the live table game. Alternatively, the indicia displayed on the video screen display may be part of a different game altogether.

The additional bets may be made by the player using casino chips in play on the live table game or by using monetary credits that have been purchased or accrued on a credit meter shown on the video display screen. These credits may be input into the video game using one or more buttons on a button panel which is operated by either the player or the dealer or by pressing designated screen locations on the video screen display. Other buttons provided on the button panel (or designated screen locations on the video screen display) could also be used by the player or the dealer to input any decisions made by the player regarding the video aspect of the game.

### EXAMPLE 1

The player plays a conventional game of live Twenty-One on the gaming table by making his wager in the conventional manner using casino gaming tokens. The game is dealt by a real, live dealer and uses a first deck or multiple decks of playing cards as is conventional. Two cards are dealt to the player and two cards are dealt to the dealer. The player plays out his Twenty-One hand in the conventional manner and the player may make additional wagers for the Twenty-One hand using casino gaming tokens as is also conventional.

For example, while playing the Twenty-One game, the player can indicate how he wishes to play his Twenty-One hand by using the conventional hand signals that indicate the player wants to Stand or take a Hit and receive an additional card. Also, as is conventional, the player can make additional wagers as would occur during a Double Down or a Splitting Pairs situation or when an Insurance wager is desired. The live dealer reacts in response to the player's hand signals and provides the player with additional cards from the first deck of cards as necessary.

The dealer plays out the dealer's hand for the Twenty-One game in the conventional manner and winning and losing player hands are determined.

The player also makes an additional bet to play another casino game, such as stud poker or draw poker, which is displayed on the video screen display contemporaneously with the play of the live table game, either using casino gaming tokens or electronic credits maintained on the electronic gaming machine mounted in the gaming table top of the Twenty-One gaming table.

At least a portion of the cards used in the stud poker or draw poker game comprise the same cards by suit and rank as at least a portion of the cards used in the live Twenty-One game.

For example, the player plays a hand of stud poker using the initial four cards comprising the player's initial two card Twenty-One hand and the dealer's initial two card Twenty-One hand. These four cards are displayed on the video screen display in front of the player.

The suit and rank of these four cards are noted by the dealer as the cards are dealt during the Twenty-One game. The dealer, using any suitable input device, such as a keypad or touch screen display, inputs the suit and rank of the first two cards dealt to the player and the first two cards dealt to the dealer. The suit and rank of these four cards is then displayed to the player on the video screen in front of the player.

Alternatively, if the Twenty-One game is dealt from a card shoe, the suit and rank of each card dealt can be read and recorded as each card is dealt. The card shoe can be provided with an optical reading device that detects the suit and rank of each card dealt from the card shoe. Or the playing cards themselves can be encoded in any suitable manner, such as by using a bar code, which is then detected by a suitable reading device as each card is dealt from the shoe. The appropriate cards so detected are then displayed to the appropriate player on the video screen in front of the player.

If the player is playing five card stud poker, then the fifth card to complete the five card stud poker is displayed to the player on the video screen display. This fifth card is dealt to the player from a depleted deck of forty-eight cards representing a standard fifty-two card deck less the four cards initially displayed to the player as the stud poker hand.

Likewise, if the player is playing six card stud poker, then the fifth and sixth cards to complete the six card stud poker are displayed to the player on the video screen display. These fifth and sixth cards are dealt to the player from a depleted deck of forty-eight cards representing a standard fifty-two card deck less the four cards initially displayed to the player as the stud poker hand.

Similarly, if the player is playing seven card stud poker, then the fifth, sixth and seventh cards to complete the seven card stud poker are displayed to the player on the video screen display. These fifth, sixth and seventh cards are dealt to the player from a depleted deck of forty-eight cards representing a standard fifty-two card deck less the four cards initially displayed to the player as the stud poker hand.

The final stud poker hand is analyzed by the computer controls of the gaming machine that is operating the video screen display to determine the poker hand ranking of the stud poker hand. Winning poker hand rankings generate an award to the player based on the amount of the player's wager and a pay table showing various winning poker hand combinations.

Alternatively, the player may also play a hand of draw poker using electronic representations of the initial four cards (the player's initial two card Twenty-One hand and the dealer's initial two card Twenty-One hand). These four cards are displayed on the video screen display in front of the player in any suitable manner such as described above. A fifth card is dealt to the player and displayed on the video screen so that the player now has a five card starting draw poker hand. As in the stud poker version discussed above, the player makes a second wager to play this draw poker hand.

The player makes his play decisions for the draw poker game by holding cards and/or discarding cards from the starting draw poker hand. The player inputs these decisions for the draw poker game by using touch screen locations on the video screen display or conventional button technology may be used in conjunction with the video screen display. Replacement cards are displayed to the player from the discarded cards in a conventional manner. Winning poker hand rankings generate an award to the player based on the amount of the player's wager and a pay table showing various winning poker hand combinations.

While the stud poker hand or the draw poker hand is being played out on the video screen display, the Twenty-One game continues on the live table game. Once each player has completed the play of his Twenty-One hand and the dealer has completed the play of his Twenty-One hand, winning wagers are paid and losing wagers are collected and the gaming table is readied for the next round of play.

Anyone familiar with playing a live game of Twenty-One knows that there is idle time for each player while the other players are playing out their hands and while the dealer is playing out his hand and collecting the losing wagers and paying the winning wagers. During this idle time, the video screen display can be utilized to allow each player to play this game of stud poker or draw poker.

### EXAMPLE 2

Another example of this type of game would allow the player to play additional or multiple hands of stud poker or draw poker simultaneously while at the same time participating in a live game of poker.

The player participates in the live poker game in the conventional manner. In one version of the present invention, the game in which the player could play multiple hands of stud poker simultaneously would operate as follows. The player would make a wager and be dealt three cards which would then be used in the live table poker game, such as seven card stud.

These three initial cards dealt would also be input into the video aspect of the game by a reading device located in the card shoe or input manually by the dealer player in any suitable manner such as described above in any suitable manner such as described above. Thus the three initial cards received by the player are also displayed electronically on the video screen in front of the player on the live table game layout. The player examines his three cards and is permitted to make one or more additional wagers to buy more stud hands using the same three initial cards.

For each additional wager by the player, the player buys another hand of stud poker. For example, if the player makes two more bets, the player is now playing a total of three stud poker hands using the same three starting cards in each hand. The first bet is allocated to the stud poker game being played on the live table game and the other two bets are allocated to different stud poker games being played and displayed on the video screen display.

After the player has made his additional wager decision, the additional three card hands are displayed on the video display and each of the player's two video stud hands are completed and evaluated by the video display according to the pay table. The dealer then pays the player for any winning hand combinations on the video screen display portion of the game. The conventional live table game portion of seven card stud poker is played out against the other players with the winning hand be awarded the pot.

This method of play of Example 2 can also be adapted to five card live table poker games such as five card draw poker. The initial five cards dealt to the player in the five card live draw poker game are also displayed to the player on his video screen display. Using these five cards, the player can play one or more hands of five card draw poker against a pay table instead of against the other players at the live table poker game.

Example 2 allows additional wagering activity to occur during the play of the live table poker game in which there is often idle time in which some players have folded and are out of the pot being contested in the live table game. This will result in additional revenue to the gaming establishment as well as providing the player with additional opportunities to achieve awards for winning outcomes during the play of the hands on the video screen display.

The foregoing are only examples of the type of games that could be employed by this new invention. While the invention has been illustrated with respect to several specific embodiments thereof, these embodiments should be considered as illustrative rather than limiting. Various modifications and additions may be made and will be apparent to those skilled in the art.

1. The method of playing a casino game comprising:
a) providing a gaming table having a plurality of player locations;
b) providing each player location with a video screen display;
c) providing each player location with a button panel associated with the video screen display;
d) dealing a live Twenty-One game in a conventional manner using actual playing cards; each player making his wagers using actual gaming tokens;
e) allowing a player to play a poker game displayed on the video screen display contemporaneously with the play of the live table game.

2. The method of claim 1 in which the poker game is stud poker and at least a portion of the stud poker game is played by using cards having the same suit and rank as a portion of the cards used in the live Twenty-One game.

3. The method of claim 1 in which the poker game is draw poker and at least a portion of the draw poker game is played by using cards having the same suit and rank as a portion of the cards used in the live Twenty-One game.
